(19) United States
(12) Patent Application Publication
(10) Pub. No.: US 2018/0063343 A1
(43) Pub. Date: Mar. 1, 2018

(54) IMAGE FORMING APPARATUS, DEVICE MANAGEMENT SYSTEM, AND NON-TRANSITORY COMPUTER READABLE MEDIUM

(71) Applicant: FUJI XEROX CO., LTD., Tokyo (JP)

(72) Inventors: Chigusa NAKATA, Kanagawa (JP); Hiroshi HONDA, Kanagawa (JP); Eiji NISHI, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP); Ryuichi ISHIZUKA, Kanagawa (JP)

(73) Assignee: FUJI XEROX CO., LTD., Tokyo (JP)

(21) Appl. No.: 15/470,383

(22) Filed: Mar. 27, 2017

(30) Foreign Application Priority Data
Aug. 29, 2016 (JP) 2016-167392

(51) Int. Cl. H04N 1/00

(52) U.S. Cl. CPC H04N 1/00251; H04N 1/00488; H04N 2201/0084; H04N 2201/0094; H04N 1/0049

(57) ABSTRACT

Provided is an image forming apparatus including
an image forming unit that forms an image,
a user interface unit that delivers information with a user,
a communication unit that communicates with a target device to be managed,
a determination unit that determines an operation state of the target device based on the communication with the target device, and
an output controller that causes information on the target device to be output through the user interface unit, the operation state of the target device being determined not to be normal by the determination unit.

### CROSS-REFERENCE TO RELATED APPLICATIONS

This application is based on and claims priority under 35 USC 119 from Japanese Patent Application No. 2016-167392 filed Aug. 29, 2016.

### BACKGROUND

### Technical Field

The present invention relates to an image forming apparatus, a device management system, and a non-transitory computer readable medium.

### SUMMARY

According to an aspect of the invention, there is provided an image forming apparatus including:

an image forming unit that forms an image;

a user interface unit that delivers information with a user;

a communication unit that communicates with a target device to be managed;

a determination unit that determines an operation state of the target device based on the communication with the target device; and

an output controller that causes information on the target device to be output through the user interface unit, the operation state of the target device being determined not to be normal by the determination unit.

### BRIEF DESCRIPTION OF THE DRAWINGS

Exemplary embodiments of the present invention will be described in detail based on the following figures, wherein:

FIG. 1 is a view illustrating the overall configuration of a device management system according to an exemplary embodiment;

FIG. 2 is a view illustrating the configuration of an image forming apparatus according to an exemplary embodiment;

FIG. 3 is a block diagram illustrating the functional configuration of a controller;

FIG. 4 is a view illustrating an example of a management table stored in a memory of the image forming apparatus;

FIG. 5 is a view illustrating an example of display on a display of the image forming apparatus;

FIG. 6 is a flowchart illustrating a process performed when a determination unit of the image forming apparatus checks the life-and-death state of each sensor S;

FIG. 7 is a view illustrating another configuration example of the device management system; and

FIG. 8 is a view illustrating another configuration example of the device management system.

### DETAILED DESCRIPTION

Hereinafter, an exemplary embodiment of the present invention will be described in detail with reference to the accompanying drawings.

### Configuration of System of this Exemplary Embodiment

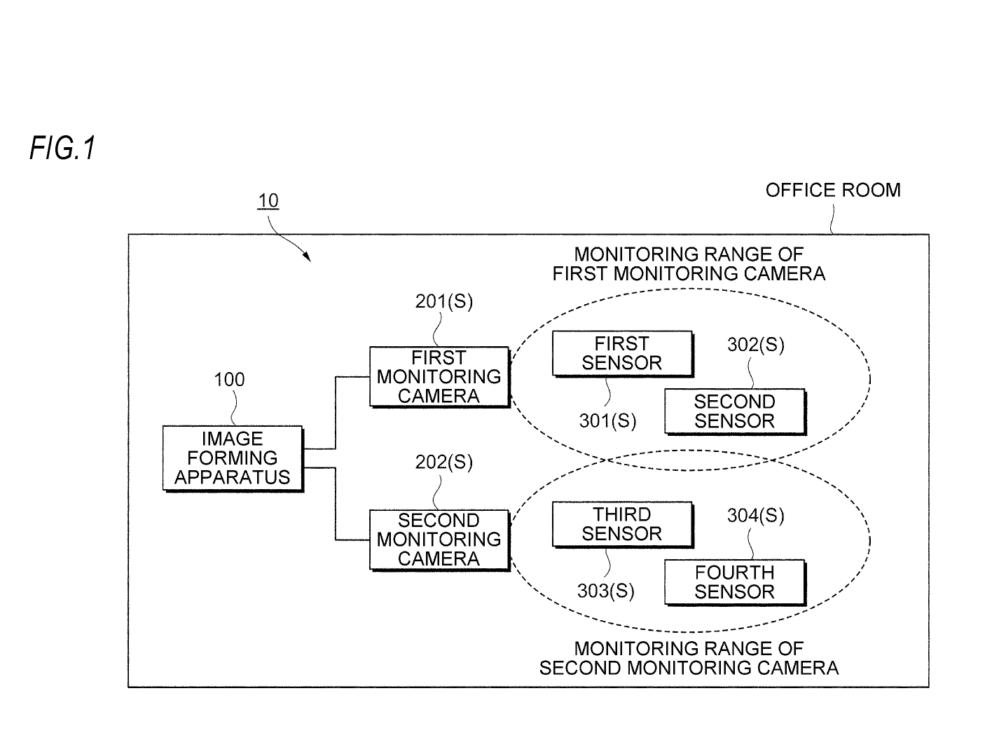

FIG. 1 is a view illustrating the overall configuration of a device management system 10 according to an exemplary embodiment.

The device management system 10 according to the present exemplary embodiment includes an image forming apparatus 100 that forms an image on a sheet which is an example of a recording material. In addition to the function of forming an image on a sheet, the image forming apparatus 100 further has a scanning function of reading an image on an original, and a FAX function of performing FAX transmission.

The device management system 10 further includes a first monitoring camera 201 and a second monitoring camera 202 functioning as situation grasping devices, and first to fourth sensors 301 to 304 also functioning as the same situation grasping devices. The first monitoring camera 201, the second monitoring camera 202 and the first to fourth sensors 301 to 304 grasp their respective surrounding situations. The situation grasping devices serve as target devices to be managed in the device management system 10 of the exemplary embodiment.

Here, the image forming apparatus 100, the first monitoring camera 201, the second monitoring camera 202 and the first to fourth sensors 301 to 304 are provided in the same office room. In addition, the first monitoring camera 201, the second monitoring camera 202 and the first to fourth sensors 301 to 304 are connected to the image forming apparatus 100 via, e.g., a network.

In this exemplary embodiment, the image forming apparatus 100 receives information on situations grasped by each of the first monitoring camera 201, the second monitoring camera 202 and the first to fourth sensors 301 to 304. The first monitoring camera 201, the second monitoring camera 202, the first to fourth sensors 301 to 304 may be connected to the image forming apparatus 100 via a wired line or over a wireless line using Wi-Fi (registered trademark), Bluetooth (registered trademark) or the like. In the present specification, hereinafter, the first monitoring camera 201, the second monitoring camera 202 and the first to fourth sensors 301 to 304 will be simply referred to as sensors S unless not distinguished from one another.

### Configuration of Image Forming Apparatus

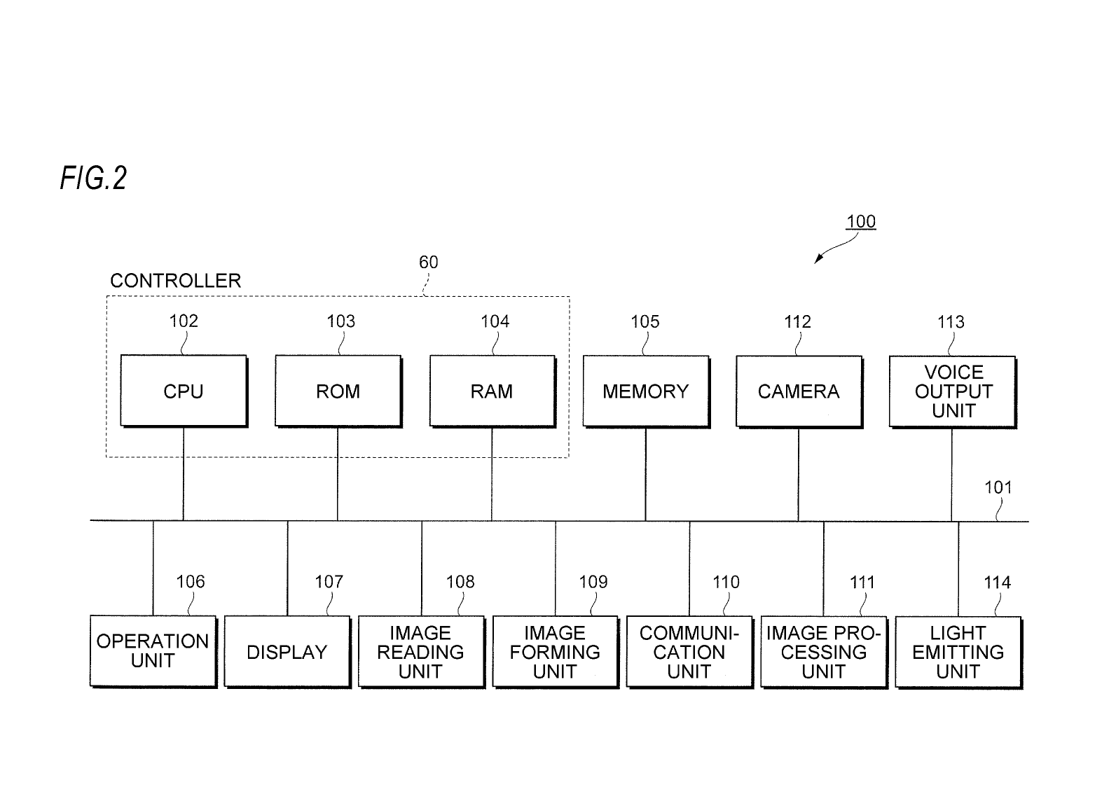

FIG. 2 is a view illustrating the configuration of the image forming apparatus 100.

In the configuration illustrated in FIG. 2, the image forming apparatus 100 includes a central processing unit (CPU) 102, a read only memory (ROM) 103 and a random access memory (RAM) 104, all of which configure a controller 60. In addition, the image forming apparatus 100 includes a memory 105, an operation unit 106, a display 107, an image reading unit 108, an image forming unit 109, a communication unit 110, an image processing unit 111, a camera 112, a voice output unit 113 and a light emitting unit 114. These functional units are connected to a bus 101 and exchange data via the bus 101.

The operation unit 106 receives a user's operation. The operation unit 106 includes, e.g., a hardware key. Alternatively, the operation unit 106 may include, e.g., a touch sensor that outputs a control signal corresponding to a pressed position. The operation unit 106 may be a touch panel which is a combination of the touch sensor and a liquid crystal display configuring the display 107 to be described below.

The display 107, as an example of a display unit, includes, e.g., a liquid crystal display and displays information on the image forming apparatus 100 under control of the CPU 102. In addition, the display 107 displays a menu screen which is referred to by a user who operates the image forming apparatus 100. Further, the display 107 displays information on the sensors S.

In other words, a combination of the operation unit 106 and the display 107 functions as a user interface unit to allow the user to deliver (input/output) information to the image forming apparatus 100. In addition, in the exemplary embodiment, the display 107 of the image forming apparatus 100 functions as an external interface for remotely operating the sensors S and remotely acquiring information on the sensors S.

The image reading unit 108 includes a so-called scanner device, optically reads an image on a set original and generates a read image (image data). As an image reading method, for example, there are a CCD (Charged Coupled Device) method in which reflected light for light irradiated on an original from a light source is reduced by a lens and is received by a CCD and a CIS (Contact Image Sensor) method in which reflected light for light sequentially irradiated on an original from a light source of an LED (Light Emitting Diode) is received by a CIS.

The image forming unit 109, as an example of an image forming unit, uses an image forming material to form an image based on image data on a sheet as an example of a recording material. As a method for forming an image on a recording material, for example, there are an electrophotographic system in which toner attached to a photoconductor is transferred onto a recording material to form an image and an inkjet method in which ink is ejected onto a recording material to form an image.

The image forming apparatus 100 further includes a communication unit 110 that functions as a receiving unit, a transmitting/receiving unit and a transmitting unit. The communication unit 110 functions as a communication interface for communicating with the sensors S or other apparatuses such as other image forming apparatuses 100. More specifically, the communication unit 110 receives information on situations grasped by each of the sensors S (hereinafter referred to as “situation information”) from each sensor S. In addition, the communication unit 110 transmits information on each sensor S to other image forming apparatuses 100. In addition, the communication unit 110 receives information on sensors S from other image forming apparatuses 100.

The image processing unit 111 includes a processor as an operation unit, and a work memory and performs an image processing such as color correction or tone correction on the image represented by the image data. The CPU 102 of the controller 60 may be used as the processor and the RAM 104 of the controller 60 may be used as the work memory.

The memory 105, as an example of a storage unit, includes a storage device such as a hard disk device and stores image data of a read image generated by the image reading unit 108. Further, in the exemplary embodiment, the memory 105 stores information on plural provided sensors S. Specifically, in the exemplary embodiment, information on the sensors S is acquired by a sensor information acquiring unit 61, which will be described later, and the memory 105 stores the information on the sensors S acquired by the sensor information acquiring unit 61. More specifically, a management table (which will be described later) used for management of the sensors S is stored in the memory 105 and the information on the sensors S is registered and managed in this management table.

The camera 112 is an example of a capturing unit and includes, e.g., CCDs (Charge Coupled Devices). In the exemplary embodiment, the situations in the office room are captured by the camera 112. More specifically, the sensors S provided in the office room are captured.

The voice output unit 113 is a notifying unit for a user and outputs a voice. Specifically, for example, the voice output unit 113 outputs an alarm sound or a voice message. The light emitting unit 114 is a notifying unit for a user and emits light with a light emitting body such as an LED or the like in a predetermined light emitting mode.

Among the CPU 102, the ROM 103 and the RAM 104 configuring the controller 60, the ROM 103 stores a program to be executed by the CPU 102. The CPU 102 reads the program stored in the ROM 103 and executes the program with the RAM 104 as a work area.

The CPU 102 executes the program to control each functional unit of the image forming apparatus 100. In the exemplary embodiment, when the program is executed by the CPU 102, the controller 60 functions as the sensor information acquiring unit 61, a storage controller 62 and a determination unit 63.

### Functional Configuration of Controller

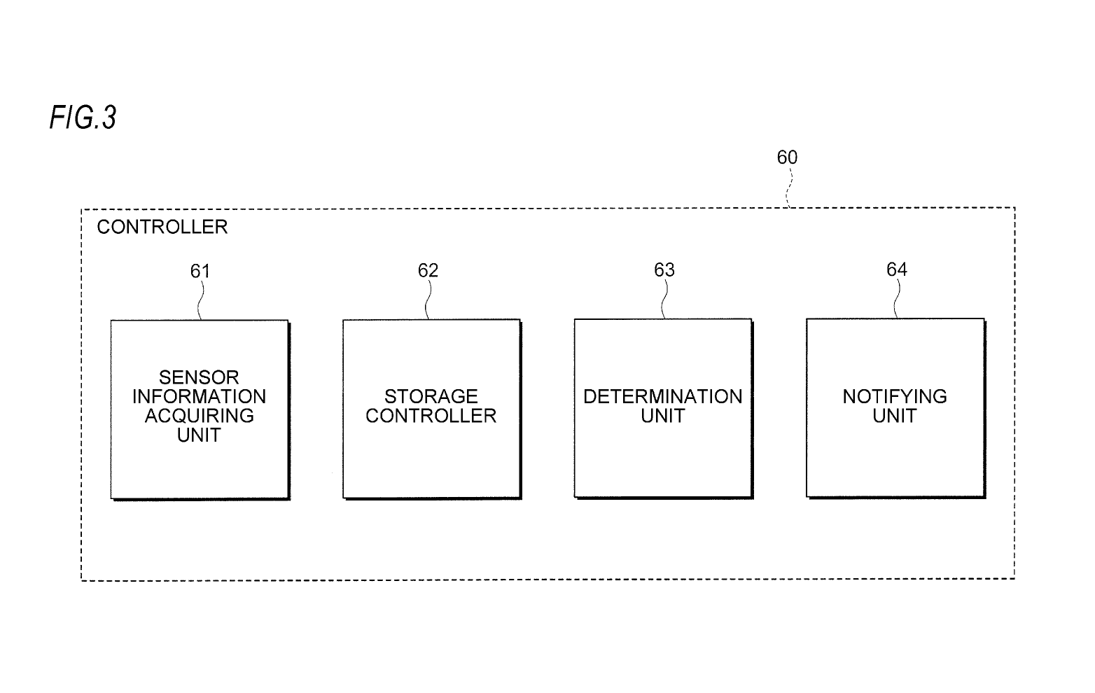

FIG. 3 is a view illustrating a functional configuration of the controller 60.

In the configuration illustrated in FIG. 3, the sensor information acquiring unit 61, as an example of an acquiring unit, acquires information on each of the plural provided sensors S. More specifically, the sensor information acquiring unit 61 acquires information on each of the sensors S, for example by receiving an operation of the operation unit 106 (see FIG. 2) by the user. In addition, the sensor information acquiring unit 61 acquires information on each of the sensors S, for example via the communication unit 110 (see FIG. 2). Further, the sensor information acquiring unit 61 may analyze a capturing result obtained by the camera 112 (see FIG. 2) to acquire the information on each sensor S. The storage controller 62 causes the memory 105 (see FIG. 2) to store the information on the sensors S acquired by the sensor information acquiring unit 61 (i.e., registers the information in the management table). The determination unit 63 grasps the state of each of the plural provided sensors S. In accordance with the state of each sensor S grasped by the determination unit 63, a notifying unit 64 uses the output units such as the display 107, the voice output unit 113, the light emitting unit 114, etc. (see FIG. 2) to inform the user of information indicating the state of each sensor S. Although not specifically illustrated, the image forming apparatus 100 may be provided with an automatic e-mail transmission function, and the notifying unit 64 may use the automatic e-mail transmission function as an output unit to transmit a message by a standard sentence or the like to the user so that the information indicating the state of each sensor S may be notified to the user.

The sensor information acquiring unit 61, the storage controller 62 and the determination unit 63 are realized by cooperation of software and hardware resources. Specifically, in the exemplary embodiment, an operating system and application programs executed in cooperation with the operating system are stored in the ROM 103 (see FIG. 2) and the memory 105. In the exemplary embodiment, the CPU 102 reads these programs from the ROM 103 or the like into the RAM 104, which is a main storage device, and executes these programs to realize the respective functional units of the sensor information acquiring unit 61, the storage controller 62 and the determination unit 63.

In the exemplary embodiment, the programs executed by the CPU 102 may be provided to the image forming apparatus 100 in a form stored in a computer-readable recording medium such as a magnetic recording medium (such as a magnetic disk), an optical recording medium (such as an optical disc), a semiconductor memory or the like. Further, the programs executed by the CPU 102 may be downloaded to the image forming apparatus 100 by a network such as the Internet.

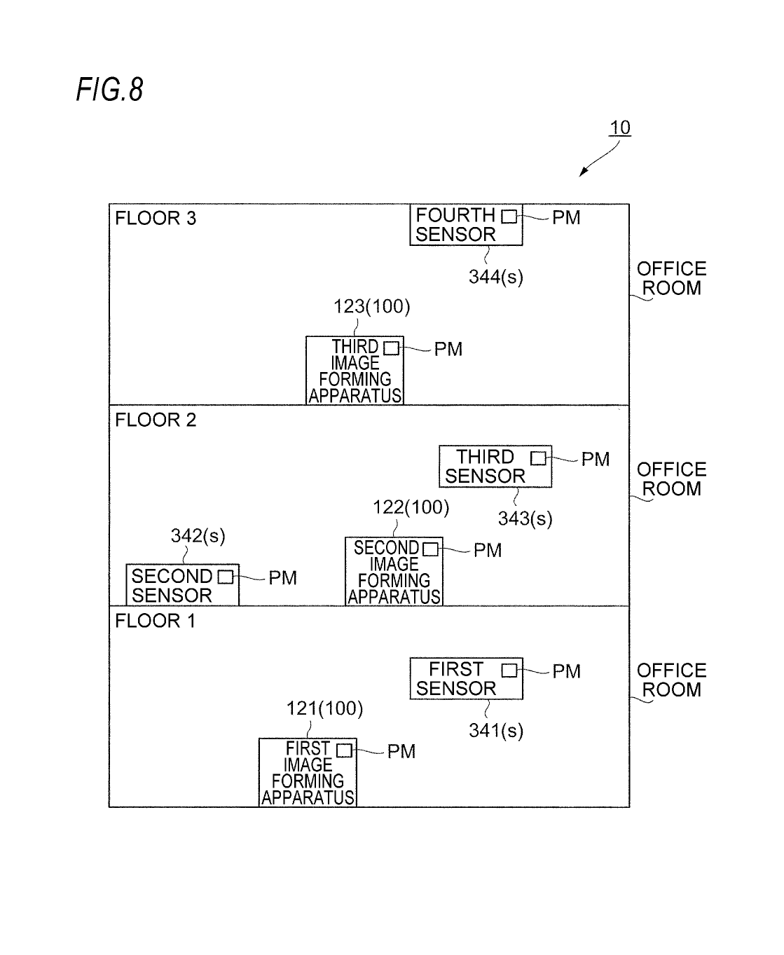

In the exemplary embodiment, as an example, the information of each sensor S is managed by the image forming apparatus 100 provided at a position close to the sensor S. When viewed from the side of the sensor S, the information of each sensor S is managed by the image forming apparatus 100 arranged at the position closest to the sensor S for each sensor S. Specifically, for example, when the sensor S and the image forming apparatus 100 are arranged on each floor in a building having plural floors as described later (FIG. 8), the information on each sensor S on each floor is managed by the image forming apparatus 100 disposed on the same floor. Further, when plural image forming apparatuses 100 are provided on the same floor, information is managed for each sensor S by the image forming apparatus 100 having the closest distance (physical distance) from the sensor S.

Here, the specific correspondence between the sensor S and the image forming apparatus 100 (correspondence indicating that information on which sensor S is managed by which image forming apparatus 100) is set, for example, by the operation of the operation unit 106 by the user. Therefore, for example, when two image forming apparatuses 100 are provided on the same floor, one image forming apparatus 100 may be set to acquire information of one sensor S, while the other image forming apparatus 100 may be set to manage the sensor S. In this case, for example, in one image forming apparatus 100, the information of one sensor S is registered in the management table of the memory 105, the information of the management table is passed to the other image forming apparatus 100 so that the sensor S is managed by the other image forming apparatus 100.

Further, when the physical position of a sensor S is obtained based on an image captured by the camera 112, the first monitoring camera 201, the second monitoring camera 202 and the like, the image forming apparatus 100 closest to the sensor S whose position is acquired manages the information on the sensor S based on information on the acquired position. With respect to a sensor S at substantially the same distance from the plural image forming apparatuses 100, for example, which image forming apparatus 100 manages the information on the sensor S is determined based on a predetermined rule. Further, only with respect to the sensor S at substantially the same distance from the plural image forming apparatuses 100, the setting on the image forming apparatus 100 may be performed by the operation of the operation unit 106 by the user.

The correspondence between the sensor S and the image forming apparatus 100 may be determined based on the physical distance as described above, or instead of the physical distance, and based on the intensity of a radio wave from the sensor S acquired by the image forming apparatus 100. Typically, when radio waves transmitted from the sensors Shave the same intensity, the intensity of a radio wave received by the image forming apparatus 100 is stronger as the distance between the sensor S and the image forming apparatus 100 is shorter. However, the intensity of the radio wave received from the sensor S by the image forming apparatus 100 may be affected by factors other than the physical distance such as a case where an obstacle is present between the sensor S and the image forming apparatus 100. Therefore, for example, in the above example, with respect to the sensor S at substantially the same distance from the plural image forming apparatuses 100, it may be set to make the image forming apparatus 100 with a strong received radio wave (receiving a stronger radio wave) correspond to the sensor S.

When anew sensor S is connected to the device management system 10, the image forming apparatus 100 detects that the new sensor S is connected to a communication line configuring the device management system 10 by UPnP (Universal Plug and Play) or the like. In this case, the storage controller 62 of the image forming apparatus 100 registers the name of the new sensor S, the position on the network and the like in the management table (the management table stored in the memory 105).

Furthermore, in the present exemplary embodiment, when the new sensor S is provided within a monitoring range of the first monitoring camera 201 or the second monitoring camera 202 which has been already provided, the name of the sensor S and its physical position are acquired from an image captured by the first monitoring camera 201 or the second monitoring camera 202. Then, the name and the position of the sensor S are output to the image forming apparatus 100, and the storage controller 62 of the image forming apparatus 100 registers the name and the position in the management table stored in the memory 105.

In other words, in the present exemplary embodiment, while the plural sensors S such as the first monitoring camera 201, the second monitoring camera 202 and the first to fourth sensors 301 to 304 are provided, some of the plural provided sensors S acquire information on other sensors S newly provided. In the present exemplary embodiment, the information on the other sensors S acquired by the some sensors S is transmitted to the image forming apparatus 100 and registered in the management table of the image forming apparatus 100.

More specifically, in the present exemplary embodiment, when the new sensor S is provided within the monitoring range of the first monitoring camera 201 or the second monitoring camera 202 that has been already provided, a result of capturing obtained by the first monitoring camera 201 or the second monitoring camera 202 is analyzed by the sensor information acquiring unit 61 (see FIG. 3) of the image forming apparatus 100 to acquire the name and type of the newly provided sensor S.

Specifically, for example, a result of capturing on a two-dimensional barcode attached to the newly provided sensor S is analyzed to acquire the name and type of the sensor S. The name and type are registered in the management table of the image forming apparatus 100.

Furthermore, in the present exemplary embodiment, the sensor information acquiring unit 61 of the image forming apparatus 100 analyzes the capturing result obtained by the first monitoring camera 201 or the second monitoring camera 202 to grasp the relative position of the new sensor S to the first monitoring camera 201 or the second monitoring camera 202. Then, the sensor information acquiring unit 61 grasps the physical (absolute) position of the new sensor S based on the grasped relative position.

Specifically, in the present exemplary embodiment, the physical position of the first monitoring camera 201 or the second monitoring camera 202 has been already registered in the management table and the sensor information acquiring unit 61 of the image forming apparatus 100 grasps the physical position of the new sensor S (position of the new sensor S in the office room) based on the physical position of the first monitoring camera 201 or the second monitoring camera 202 already registered in the management table and the relative position. Then, the storage controller 62 of the image forming apparatus 100 registers the physical position in the management table.

The physical position of the newly provided sensor S may be grasped based on the intensity and direction of a radio wave transmitted from the newly provided sensor S, which are grasped by the image forming apparatus 100, the first monitoring camera 201 or the second monitoring camera 202.

Further, in the exemplary embodiment, the determination unit 63 of the image forming apparatus 100 grasps the life-and-death state of a sensor S at each predetermined timing. More specifically, the determination unit 63 performs, e.g., ping periodically on a sensor S registered in the management table or determines whether or not a push notification has come from the sensor S at each predetermined timing, to thereby determine whether or not the sensor S is working normally. Then, the determination unit 63 registers the state of each sensor S in the management table.

The state of the sensor S may be grasped by capturing each sensor S with the first monitoring camera 201, the second monitoring camera 202, the camera 112 included in the image forming apparatus 100, or the like. More specifically, the state of each sensor S may be grasped by analyzing a capturing result obtained by the first monitoring camera 201, the second monitoring camera 202, the camera 112 of the image forming apparatus 100, or the like.

More specifically, the light emission state of a light source provided in each sensor S may be grasped by the first monitoring camera 201, the second monitoring camera 202, the camera 112 of the image forming apparatus 100, or the like, and the state of the sensor S may be grasped based on this light emission state. For example, a light source such as an LED is provided in each sensor S and is lit up/down at each predetermined timing. Then, the determination unit 63 (see FIG. 3) of the image forming apparatus 100 analyzes the capturing result obtained by the first monitoring camera 201, the second monitoring camera 202, the camera 112 of the image forming apparatus 100, etc., to determine whether the light source of the sensor S is lit up or lit down under a predetermined condition. Then, when the light source is lit up or lit down under a predetermined condition, the determination unit 63 determines that the sensor S is working normally. Meanwhile, when the light source is not lit up or not lit down under the predetermined condition, the determination unit 63 determines that the sensor S is not working normally.

The light source may be provided for all the sensors S, or may be provided only in some of the sensors S, such as only in sensors S seen from the image forming apparatus 100 or sensors S capable of being captured by the first and second monitoring cameras 201 and 202.

### Display of Information by Image Forming Apparatus

Furthermore, in the present exemplary embodiment, when the user operates the operation unit 106 (see FIG. 2) of the image forming apparatus 100, the positional relationship of the sensors S provided in the office room is displayed on the display 107 of the image forming apparatus 100. More specifically, in the present exemplary embodiment, the physical positions of the sensors S are displayed on the display 107 of the image forming apparatus 100. Thus, by referring to the display 107, for example, the user may grasp where the sensor S is present in the office room. An object to be displayed on the display 107 is not limited to the physical positions of the sensors S but may be positions of the sensors S on a network. Further, a list of information registered in the management table may be displayed on the display 107. Furthermore, the position (physical position, and position on the network) of the sensor S, the registration information of the management table and the life-and-death information of each sensor S may be displayed on the display 107. Furthermore, as a result of grasping of the state of the sensor S based on the regular processing and the like as described above, when a sensor S not working normally is detected, the notifying unit 64 (see FIG. 3) of the controller 60 may display the information identifying the detected sensor S and the information indicating that the sensor S is not working normally, on the display 107 to notify the information to the user. In other words, the notifying unit 64 functions as an output controller that outputs information on the sensor S determined by the determination unit 63 that the sensor S is not working normally. As a method of notifying the information on the sensor S which is not working normally, in addition to displaying the information on the display 107, there are a method of notifying the information by voice using the voice output unit 113 (see FIG. 2) and a method of notifying the information by light emission using the light emitting unit 114 (see FIG. 2). Furthermore, if the notifying unit 64 of the controller 60 has an e-mail issuing function, an e-mail notifying a management user that there is a sensor S not working normally may be transmitted to the management user.

Further, in the present exemplary embodiment, when the user selects a sensor S from the plural sensors S displayed on the display 107 of the image forming apparatus 100, the image forming apparatus 100 instructs the selected sensor S to light up or down the light source. As a result, the light source of the sensor S is lit up or down so that the user may more easily find the sensor S in the office room by referring to this lighting-up/down. In addition, the user may recognize that the communication between the sensor S in the office room and the image forming apparatus 100 is established by checking this lighting-up/down. Specifically, some or all of the sensors S according to the exemplary embodiment have their respective receiving units that receive an instruction from the image forming apparatus 100. Upon receiving a light source lighting-up/down instruction in the receiving units, the sensors S light up or down their respective light sources. In this case, by referring to this lighting-up/down, the user may more easily find the sensor S in the office room and may recognize that the communication between the sensor S in the office room and the image forming apparatus 100 is established.

### Management Table

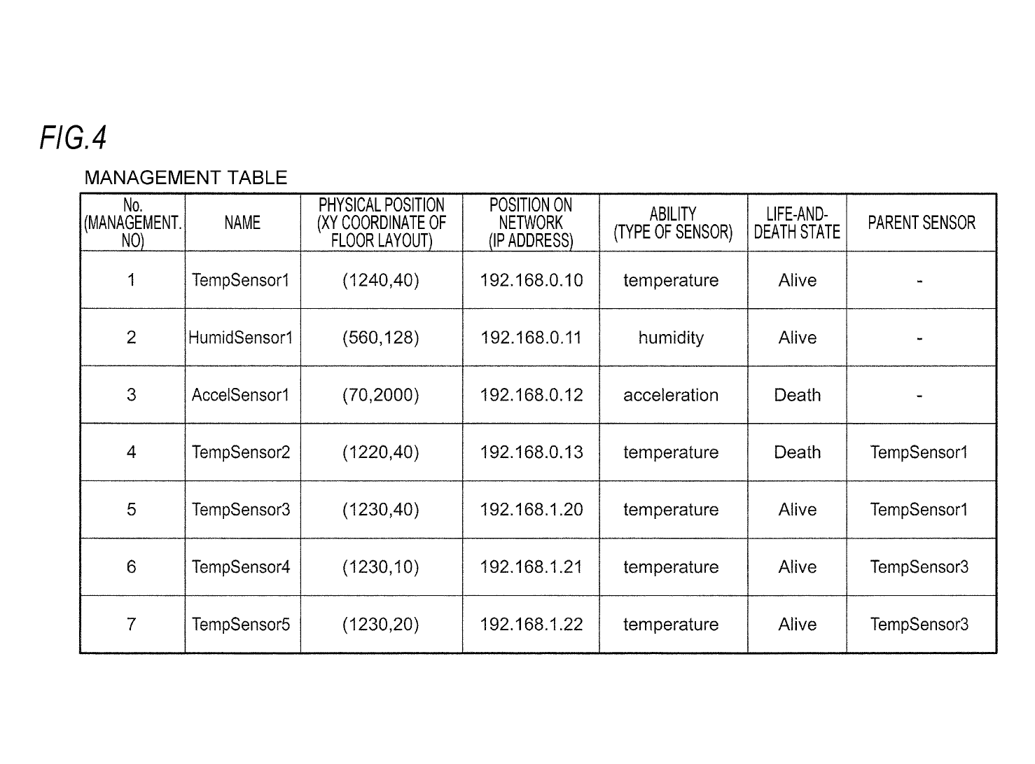

FIG. 4 is a view illustrating an example of the management table stored in the memory 105 of the image forming apparatus 100.

Information on each sensor S is registered in the management table of the present exemplary embodiment. More specifically, information on a management number, name, physical position (XY Coordinate of Floor Layout), position (IP address) on a network, ability (the type of the sensor S), the life-and-death state and a parent sensor S is registered in the management table in association.

In the present exemplary embodiment, when the user operates the operation unit 106 of the image forming apparatus 100, the management table is displayed on the display 107 to allow the user to check a list of the sensors S provided in the office room. Furthermore, in the present exemplary embodiment, when anyone of the sensors S is selected from this list by the user, as described above, the light source of the sensor S is lit up or down to allow the user to confirm the position or the life-and-death state of the sensor S in the office room based on this lighting-up/down.

Further, in the present exemplary embodiment, as described above, the information on the management number, the name, the physical position, the position on a network, the ability, the life-and-death state and the parent sensor S may be associated with each other. As a result, when some of the information on the sensor S such as the name of the sensor S is input to the operation unit 106 by the user, other information on the sensor S such as the physical position and the position on the network of the sensor S may be checked.

### Display example on Display of Image Forming Apparatus

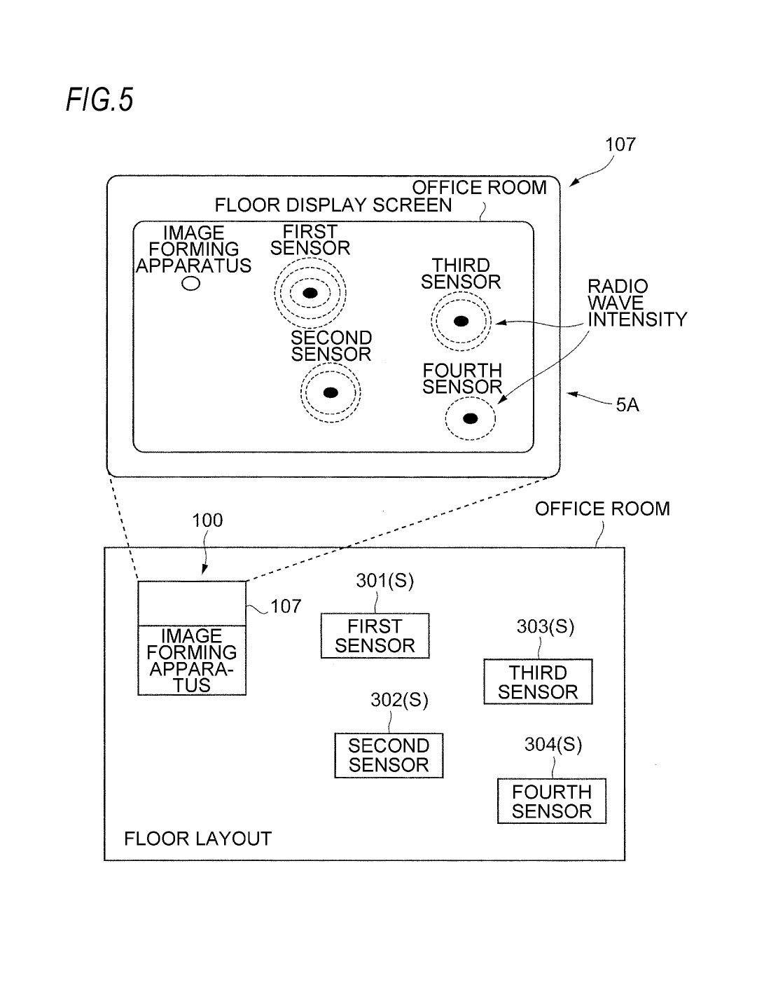

FIG. 5 is a view illustrating a display example on the display 107 of the image forming apparatus 100.

In the present exemplary embodiment, as described above, a physical position is acquired for each sensor S and information on this physical position is registered in the management table. In the present exemplary embodiment, when the user operates the operation unit 106 and requests the operation unit 106 to display the position of the sensor S, information on the physical position of each sensor S is read from the management table and the position of each sensor S is displayed on the display 107 of the image forming apparatus 100, as indicated by reference numeral 5A of FIG. 5. In this display, the position of the image forming apparatus 100 is also displayed. In addition, in this display, the office room is also displayed. By referring to this display on the display 107, the user may grasp the position of the sensors S in the office room.

Although FIG. 5 is a top view (a view when viewing the office room from above), a side view (a view when viewing the office room from the side) may be displayed. In a case where the side view is displayed, it is possible to grasp the position of each sensor S in the vertical direction in the office room. In addition, although the case where the physical position of each sensor S is displayed on the display 107 has been described here, an image indicating the physical position of each sensor S may be formed on a sheet by the image forming unit 109 and the sheet displaying the image indicating the physical position of each sensor S may be output.

In the display shown in FIG. 5, not only the position information of each sensor S but also information on the office room (such as information on the size and shape of the office room) is also required. The information on the office room may be acquired, for example, by scanning a floor map, on which the office room is located, with the image forming apparatus 100 to take the floor map into the image forming apparatus 100 and by analyzing the floor map (a scanned image of the floor map) with the image forming apparatus 100.

Further, for example, electronic data obtained by digitizing the floor map of the office room may be transmitted from. a Personal Computer (PC) or the like to the image forming apparatus 100 so that the information on the office room may be taken into the image forming apparatus 100. Further, for example, the information on the office room may be acquired by running a self-propelled robot equipped with a camera in the office room. In the present exemplary embodiment, in performing the display illustrated in FIG. 5, the image forming apparatus 100 generates an image in which a sensor S is superimposed on the floor map, and displays the generated image on the display 107.

### Management of Sensor by Image Forming Apparatus 100

In the present exemplary embodiment, information on the plural sensors S provided in the office room is stored in the image forming apparatus 100 and is consolidated in one place. Therefore, by operating the image forming apparatus 100, the user may check the information on all the sensors S provided in the office room. The management of the sensors S may be performed by individual providers who have provided the sensors S. However, in this case, the information may be diffused so that the sensors S may not be fully managed.

Furthermore, in the present exemplary embodiment, the information on the sensors S is stored in the image forming apparatus 100 rather than a PC or the like possessed by the user. Once the image forming apparatus 100 is provided in the office room, the image forming apparatus 100 is not frequently moved. Therefore, when the information on the sensors S is stored in the image forming apparatus 100, the information on the sensors S will hardly be moved (diffused). Furthermore, since the number of provided image forming apparatuses 100 is smaller than the PCs or the like, when the information of the sensors S is stored in the image forming apparatus 100, the information of the sensors S is hardly distributed and stored in plural apparatuses.

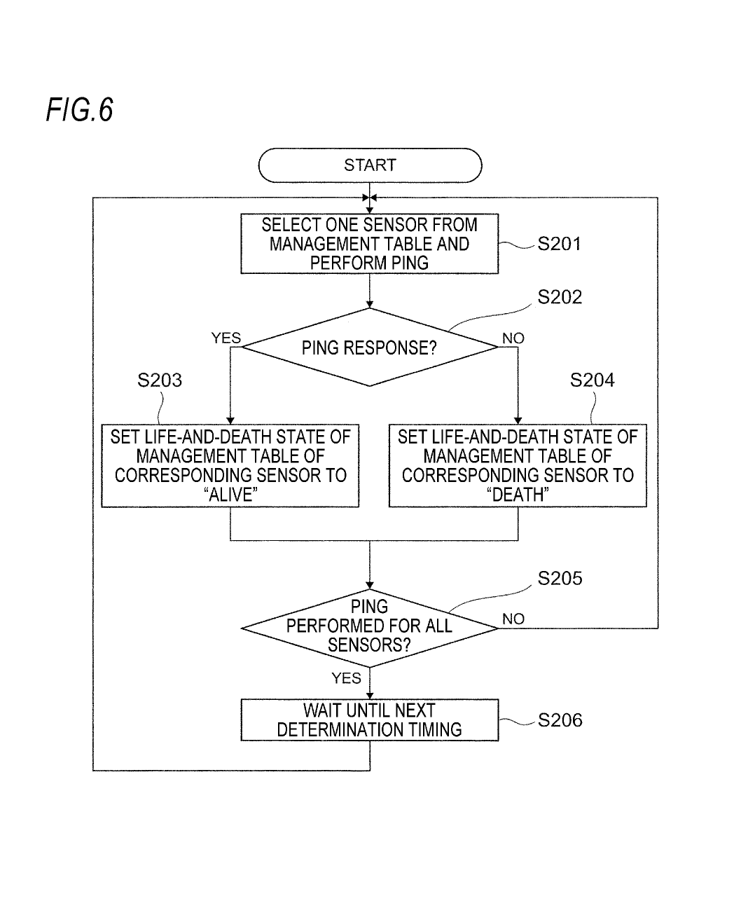

FIG. 6 is a flowchart illustrating a flow of process executed by the determination unit 63 of the image forming apparatus 100 when checking the life-and-death state of each sensor S.

FIG. 6 illustrates an example where ping is used to check the life-and-death state of each sensor S. First, the determination unit 63 (see FIG. 3) of the image forming apparatus 100 selects one sensor S from the management table and pings the selected sensor S (step 201). Then, the determination unit 63 determines whether or not there is aping response (step 202).

When it is determined that there is a ping response, the determination unit 63 determines that the sensor S is working and sets the life-and-death state of the sensor S to “alive” (step 203). More specifically, in the exemplary embodiment, as illustrated in FIG. 4, a field for registering the life-and-death state of each sensor S is provided in the management table, and the determination unit 63 registers information of “alive” indicating that the sensor S is working in the field indicating the life-and-death state for the working sensor S.

Meanwhile, if it is determined in step 202 that there is no ping response, the determination unit 63 determines that the sensor S is not working, and sets the life-and-death state to “death” (step 204). More specifically, the determination unit 63 registers the information of “death” in the field indicating the life-and-death state in the management table for the sensor S not working, as illustrated in FIG. 4.

Thereafter, the determination unit 63 determines whether or not ping has been performed for all the sensors S (step 205). When it is determined that ping has been performed for all the sensors S, the determination unit 63 waits until the next determination timing comes (step 206). On the other hand, if it is determined in step 205 that ping has not been performed for all the sensors S, the determination unit 63 performs the process again subsequently to the step 201.

In the meantime, the sensor S is not limited to the fixed arrangement but may include a so-called wearable sensor S (portable sensor S) which is moved within the office room. In this case, the physical position of the sensor S may be grasped based on signals (indicating positions) transmitted from plural transmitters provided in the office room.

Specifically, in this case, the sensor S grasps its own position (physical position) based on a radio wave transmitted from a transmitter, and outputs this position to the image forming apparatus 100. Accordingly, the image forming apparatus 100 grasps the position of the sensor S. Then, as described above, the image forming apparatus 100 registers the physical position of the sensor S in the management table. In addition, in order to register the position of the sensor S in the management table, a provider who provides the sensor S may input the position information of the sensor S through the operation unit 106 (see FIG. 2) of the image forming apparatus 100. Further, the physical position of the sensor S may be grasped by using a terminal (such as a tablet terminal or a smartphone) owned by the provider who provides the sensor S.

In this case, for example, a number of transmitters (transmitting signals indicating provision positions) are provided in the office room in advance. The provider provides the terminal at a provision scheduled position of the sensor S, receives a radio wave transmitted from a transmitter at this terminal, and obtains the position information of the provision scheduled position of the sensor S. Thereafter, the provider operates the operation unit 106 or the like of the image forming apparatus 100 to register the position information in the management table of the image forming apparatus 100.

Further, a case is considered where the display 107 of the image forming apparatus 100 is set as an external interface of the sensor S and the life-and-death information of the wearable sensor S is displayed. In this case, the user wearing the wearable sensor S approaches the image forming apparatus 100 and places its own sensor S under the control of the image forming apparatus 100, thereby checking the information displayed on the display 107 to determine whether or not its own sensor S is working normally.

### Another Configuration Example of Device Management System

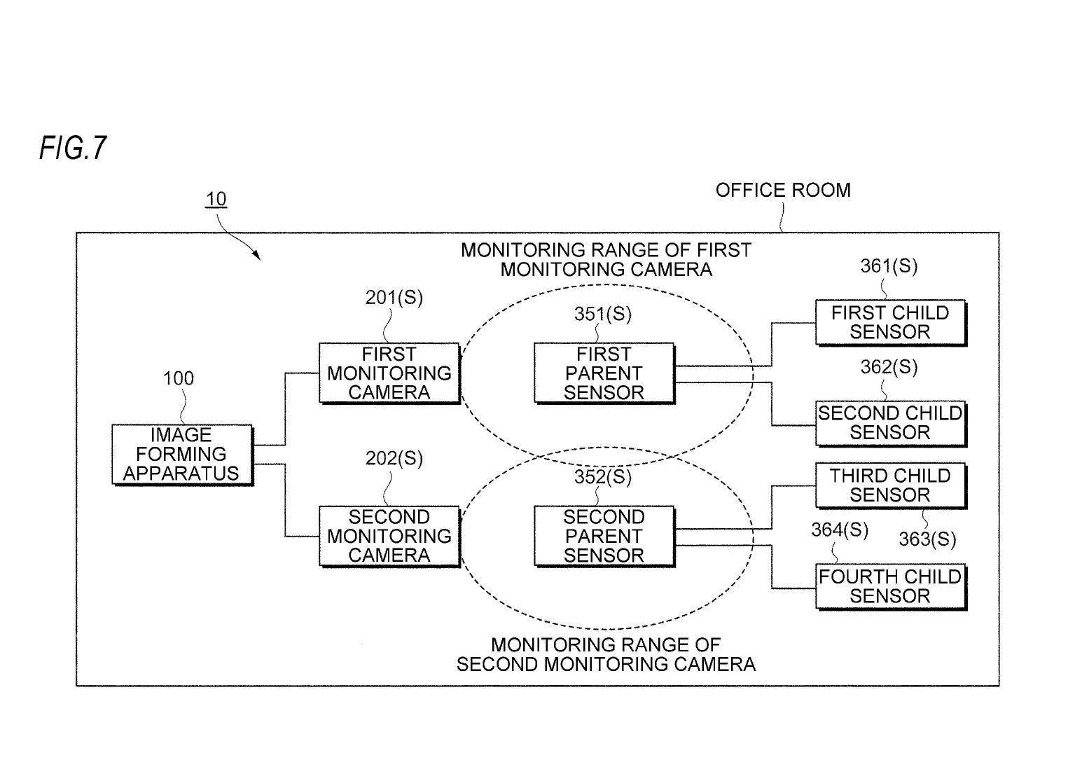

FIG. 7 is a view illustrating another configuration example of the device management system 10.

In the device management system 10, sensors S are arranged in a tree structure and the upper sensor S specifies the physical position of the lower sensor S. More specifically, in the device management system 10, it is assumed that the first monitoring camera 201 and the second monitoring camera 202 have been already provided and, thereafter, parent sensors S (a first parent sensor 351 and a second parent sensor 352) and child sensors S (first to fourth child sensors 361 to 364) are provided.

In this configuration example, first, the first parent sensor 351 and the second parent sensor 352 are provided within the monitoring ranges of the first monitoring camera 201 and the second monitoring camera 202. In the same manner as described above, the name and physical position of the first parent sensor 351 and the second parent sensor 352 are specified by the first monitoring camera 201 and the second monitoring camera 202, and information such as the name and physical position for the first parent sensor 351 and the second parent sensor 352 is registered in the management table.

Next, in this example, the child sensors S are placed below the parent sensors S. Specifically, the first child sensor 361 and the second child sensor 362 are placed below the first parent sensor 351, and the third child sensor 363 and the fourth child sensor 364 are placed below the second parent sensor 352. In other words, the plural child sensors S are placed within a range where the plural child sensors S may communicate with the parent sensors S. Then, the parent sensors S specify the intensities and directions of radio waves transmitted from the child sensors S to specify the physical positions of the child sensors S. Further, in this configuration example, information on the child sensors S (such as the names and types of the child sensors S) is transmitted from the child sensors S to the parent sensors S.

Then, the parent sensors S transmit the position information (physical position information) of the child sensors S and the information (information such as the names and types of the child sensors S) obtained by the child sensors S to the image forming apparatus 100. Further, the parent sensors S transmit their own information (information such as the names and types of the parent sensors S) to the image forming apparatus 100. In the image forming apparatus 100, the information (the information of the parent sensors S and the child sensors S) transmitted from the parent sensors S is registered in the management table.

In this configuration example, the image forming apparatus 100 does not directly grasp the information on the child sensors S. The positions of the child sensors S are grasped by the parent sensors S and the image forming apparatus 100 grasps the positions of the child sensors S based on the information from the parent sensors S. The information such as the name of the child sensors S is also transmitted to the image forming apparatus 100 via the parent sensors S. The image forming apparatus 100 obtains the information on the child sensors S from the information transmitted from the parent sensors S. In other words, in this configuration example, the information on some of the plural provided sensors S is acquired by other sensors S. Then, the image forming apparatus 100 acquires information from the other sensors S to acquire the information on the some sensors S.

FIG. 8 is a view illustrating a further configuration example of the device management system 10.

In this configuration example, four sensors S, namely first to fourth sensors 341 to 344, are provided. Furthermore, each of the sensors S includes a barometer PM. Also, in this configuration example, plural floors, first to third floors, each having an office room, are provided. Further, a sensor S is provided in each office room. An image forming apparatus 100 is provided in each office room. Further, a barometer PM is also provided in each image forming apparatus 100.

In this configuration example, a radio wave transmitted from each of the first sensor 341, the second sensor 342 and the third sensor 343 is received by a first image forming apparatus 121 provided on the first floor, and the first image forming apparatus 121 acquires an atmospheric pressure value obtained by each of the first sensor 341, the second sensor 342 and the third sensor 343.

Further, the first image forming apparatus 121 compares the atmospheric pressure value obtained by the barometer PM of the first image forming apparatus 121 with the atmospheric pressure value obtained by each of the first sensor 341, the second sensor 342 and the third sensor 343 to grasp a sensor S provided on the same floor as its own provision floor. In this example, the atmospheric pressure value obtained by the first image forming apparatus 121 and the atmospheric pressure value obtained by the first sensor 341 are close to each other, and the first image forming apparatus 121 determines that the sensor S provided on the same floor as its own provision floor is the first sensor 341.

Then, the first image forming apparatus 121 registers only information on the first sensor 341 provided on the same floor as its own provision floor in its own management table. In other words, the first image forming apparatus 121 registers only the first sensor 341 provided between the bottom of the first floor and the ceiling thereof in the management table.

Furthermore, in this configuration example, the information indicating that the first image forming apparatus 121 is provided on the first floor (information on the provision floor of the first image forming apparatus 121) is stored in advance in the first image forming apparatus 121. In this configuration example, each of a second image forming apparatus 122 and a third image forming apparatus 123 acquires the information indicating that the first image forming apparatus 121 is provided on the first floor and the atmospheric pressure value obtained by the first image forming apparatus 121 from the first image forming apparatus 121.

The second image forming apparatus 122 and the third image forming apparatus 123 grasp their own provision floors based on the atmospheric pressure values obtained by the barometers PM of their own and the atmospheric pressure value obtained by the first image forming apparatus 121. In this example, the second image forming apparatus 122 grasps that its own provision floor is the second floor, and the third image forming apparatus 123 grasps that its own provision floor is the third floor.

Further, like the first image forming apparatus 121, the second image forming apparatus 122 registers the sensor S located on the same floor as the floor where the second image forming apparatus 122 is provided, in the management table. Specifically, the second image forming apparatus 122 compares the atmospheric pressure value obtained by the barometer PM of its own with the atmospheric pressure value obtained by each sensor S to grasp the sensor S provided on the same floor as the provision floor of its own. Then, only information on this sensor S is registered in its own management table. In this example, the second image forming apparatus 122 grasps that the second sensor 342 and the third sensor 343 are sensors S provided on the same floor as the provision floor of its own, and information on the second sensor 342 and the third sensor 343 is registered in the management table of the second image forming apparatus 122.

The same applies to the third image forming apparatus 123. The third image forming apparatus 123 registers the fourth sensor 344 located on the same floor as the floor where the third image forming apparatus 123 is provided, in its own management table. Specifically, the third image forming apparatus 123 compares the atmospheric pressure value obtained by its own barometer PM with the atmospheric pressure value obtained by each sensor S to grasp the sensor S provided on the same floor as its own provision floor. Then, information on this sensor S is registered in its own management table. Specifically, the third image forming apparatus 123 grasps that the fourth sensor 344 is the sensor S provided on the same floor as its own provision floor, and registers information on the fourth sensor 344 in its own management table of the third image forming apparatus 123.

In the configuration example illustrated in FIG. 8, a reference image forming apparatus 100 (in this example, the first image forming apparatus 121) is determined, and information on its own provision floor is registered in the reference image forming apparatus 100. The other image forming apparatus 100 acquires the information and atmospheric pressure value on the provision floor of the reference image forming apparatus 100 from the reference image forming apparatus 100. Then, based on the atmospheric pressure value of the other image forming apparatus 100, the atmospheric pressure value acquired from the reference image forming apparatus 100 and the provision floor of the reference image forming apparatus 100, the other image forming apparatus 100 grasps which floor it is located on.

More specifically, in this configuration example, each of the image forming apparatuses 100 and the sensors S includes a barometer PM to acquire an atmospheric pressure value. In this configuration example, when the atmospheric pressure value obtained by an image forming apparatus 100 is close to the atmospheric pressure value obtained by a sensor S, it is determined that the image forming apparatus 100 and the sensor S are provided on the same floor, and information on this sensor S is registered in a management table of the image forming apparatus 100.

Meanwhile, if a difference between the atmospheric pressure value obtained by the image forming apparatus 100 and the atmospheric pressure value obtained by the sensor S is large, it is determined that the image forming apparatus 100 and the sensor S are provided on different floors. In this case, the information on this sensor S is registered in a management table of an image forming apparatus 100 provided at a different floor.

Here, there are cases where plural image forming apparatuses 100 are provided. More specifically, as illustrated in FIG. 8, the image forming apparatuses 100 are provided in different office rooms in different provision floors or plural image forming apparatuses 100 are provided in one office room. In the case where the plural forming apparatuses 100 are provided in this way, the image forming apparatuses 100 may communicate with each other and share the information so that sensors S managed by the respective image forming apparatuses 100 do not overlap each other. In other words, one sensor S may not be registered in the plural image forming apparatuses 100.

Here, in the case where the plural image forming apparatuses 100 are provided, in a case where a radio wave (signal) from one sensor S is received by the plural image forming apparatuses 100 (a case where there is a possibility that one sensor S is managed by the plural image forming apparatuses 100), for example, one image forming apparatus 100 receiving a stronger radio wave manages this sensor S in preference. The reason is that the stronger the radio wave is, the lower the possibility that the communication will be disconnected.

Here, the determination of the one image forming apparatus 100 that manages the sensor S is performed, for example, by transmitting the intensity of the radio wave received by each of the image forming apparatuses 100 to the other image forming apparatus 100 and comparing the intensities of radio waves in each of the image forming apparatuses 100. More specifically, each of the image forming apparatuses 100 compares the intensity of its own received radio wave with the intensity of the radio wave transmitted from the other image forming apparatus 100, and when the intensity of its own received radio wave is the largest, manages the sensor S by itself. Meanwhile, when the intensity of its own received radio wave is not the largest, it means that the intensity of the radio wave received by the other image forming apparatus 100 is larger. In this case, the other image forming apparatus 100 manages the sensor S.

More specifically, each of the image forming apparatuses 100 includes a communication unit 110 (see FIG. 2) functioning as a transmitting/receiving unit, and transmits the intensity of its own received radio wave (information on the sensor S acquired by itself) to the other image forming apparatus 100. Further, each of the image forming apparatuses 100 receives the intensity of the radio wave received by the other image forming apparatus 100 (information on the sensor S acquired by the other image forming apparatus 100) from the other image forming apparatuses 100. Then, each of the image forming apparatuses 100 determines whether or not the intensity of its own received radio wave is the largest, and manages the sensor S which has transmitted the radio wave when the intensity is the largest.

### Control of Notification of Sensor State by Image Forming Apparatus

In a case where various kinds of sensors S are provided in various environments, the importance of information obtained by each sensor S may be varied according to sensors S. In such a case, a method or priority of notification to be performed when it is detected that the sensor S is not working normally may be made different according to the type, individual, error content, etc. of the sensor S. Specifically, setting information in which the priority of notification is set according to the type, individual, error content, etc. of the sensor S is stored in the memory 105, and the notifying unit 64 performs notification with the priority according to the type, individual, error content, etc. of the sensor S grasped by the determination unit 63, based on the setting information.

For example, a sensor S acquiring information on the environments such as temperature and humidity inside the office room may be set to low priority, a sensor S acquiring information on security such as door locking status may be set to high priority, and notification may be performed when it is detected that the sensor S is not working normally. When it is detected that the sensor S set to the high priority is not working normally, even if it is detected that other sensors S are not working normally, notification for a sensor S set to the high priority is performed in preference. In addition, the notification for the sensor S set to the high priority may be performed using a notifying method such as voice of the voice output unit 113 or light emission of the light emitting unit 114 so that the user may recognize the occurrence of abnormality even from a place away from the image forming apparatus 100, or may be performed in duplicate by plural notifying methods so as to notify the occurrence of abnormality to the user more reliably. Further, when the image forming apparatus 100 has an e-mail issuing function, notification may be performed by transmitting an e-mail to a management user of the sensor S.

Even for a sensor S that acquires information on the environments such as temperature and humidity inside the office room, depending on a provision location, the sensor S may be set to a high priority. For example, the provision location (a server room) of a server device is controlled so that the room temperature is not greatly changed by strict temperature adjustment in order to keep the server device with high load in a stable operation. Therefore, the importance of temperature information obtained from a temperature sensor (sensor S) provided in the server room is high. Therefore, the temperature sensor provided in such an environment is set to a high priority. Then, when it is detected that the temperature sensor of the server room is not working normally (for example, the temperature information is not sent, the sent temperature information has an abnormal value, etc.), it has to be promptly notified to a management user. Therefore, in such a case, instead of or in addition to displaying the life-and-death information of the sensor S on the display 107, it may be directly notified to the management user by transmitting an e-mail to the management user. In addition, when it is detected that some including the temperature sensor among sensors S provided in the server room are not working normally, the abnormality of the temperature sensor may be preferentially notified.

Each of the image forming apparatuses 100 and the sensors S may have plural interfaces, in which a case, the interfaces to be used may be switched. The switching of the interfaces is performed, for example by sending a signal, which indicates the switching of the interfaces to be used, from the corresponding image forming apparatus 100 to the corresponding sensor S.

Further, the image forming apparatus 100 may be connected to a cloud or an external server, and information from the sensor S may be output to the cloud or the external server via the image forming apparatus 100. Furthermore, the output of each sensor S may be monitored by the cloud or the external server, and the cloud or the external server may manage an office room based on the output of each sensor S.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
at least one processor configured to execute:
an image forming unit configured to form an image;
a communication unit configured to communicate with a target device; and
an output controller configured to, in response to the communication unit trying to communicate with the target device and the target device being abnormal, output information about the target device being abnormal.

2. The image forming apparatus according to claim 1, wherein the image forming apparatus further comprises a user interface, and
wherein the information about the target device being abnormal, is output using the user interface and includes a position of the target device.

3. The image forming apparatus according to claim 1, wherein the image forming apparatus further comprises a user interface.
wherein the user interface includes a display configured to display information, and
wherein the output controller is configured to cause the information about the target device being abnormal to be displayed on the display in response to an operation state of the target device being determined to be abnormal.

4. The image forming apparatus according to claim 2, wherein the user interface includes a display configured to display information, and
wherein the output controller is configured to cause the information about the target device being abnormal to be displayed on the display in response to an operation state of the target device being determined to be abnormal.

5. The image forming apparatus according to claim 1, wherein the at least one processor is further configured to execute a voice output unit configured to output a voice, and
wherein the output controller is configured to cause the voice output unit to output a predetermined voice in response to the target device being present and an operation state of the target device being determined to be abnormal.

6. The image forming apparatus according to claim 2, wherein the at least one processor is further configured to execute a voice output unit configured. to output a voice, and
wherein the output controller is configured to cause the voice output unit to output a predetermined voice in response to the target device being present and an operation state of the target device being determined to be abnormal.

7. The image forming apparatus according to claim 3, wherein the at least one processor is further configured to execute a voice output unit configured to output a voice, and
wherein the output controller is configured to cause the voice output unit to output a predetermined voice in response to the target device being present and an operation state of the target device being determined to be abnormal.

8. The image forming apparatus according to claim 4, wherein the at least one processor is further configured to execute a voice output configured to output a voice, and
wherein the output controller is configured to cause the voice output unit to output a predetermined voice in response to the target device being present and an operation state of the target device being determined to be abnormal.

9. The image forming apparatus according to claim 1, further comprising:
a light emitter,
wherein the output controller is configured to cause the light emitter to emit light in a predetermined emission manner in response the a target device being present; and an operation state of the target device being determined to be abnormal.

10. The image forming apparatus according to claim 2, further comprising:
a light emitter,
wherein the output controller is configured to cause the light emitter to emit light in a predetermined emission manner in response to the target device being present and an operation state of the target device being determined to be abnormal.

11. The image forming apparatus according to claim 3, further comprising:
a light emitter,
wherein the output controller is configured to cause the light emitter to emit light in a predetermined emission manner in response to the target device being present and an operation state of the target device being determined to be abnormal.

12. The image forming apparatus according to claim 4, further comprising:
a light emitter,
wherein the output controller is configured to cause the light emitter to emit light in a predetermined emission manner in response to a target device being present and the operation state of the target device being determined to be not normal.

13. The image forming apparatus according to claim 5, further comprising:
a light emitter,
wherein the output controller is configured to cause the light emitter to emit light in a predetermined emission manner in response to the target device being present and an operation state of the target device being determined to be abnormal.

14. The image forming apparatus according to claim 6, further comprising:
a light emitter,
wherein the output controller is configured to cause the light emitter to emit light in a predetermined emission manner in response to the a target device being present and an operation state of the target device being determined to be abnormal.

15. The image forming apparatus according to claim 7, further comprising:
a light emitter,
wherein the output controller is configured to cause the light emitter to emit light in a predetermined emission manner in response to the target device being present and an operation state of the target device being determined to be abnormal.

16. The image forming apparatus according to claim 1, wherein the output controller is configured to set a priority with which the information about the target device being abnormal is output according to predetermined setting information.

17. The image forming apparatus according to claim 16, wherein the image forming apparatus further comprises a user interface,
wherein the output controller further includes an output unit that is different from the user interface,
wherein the output unit is configured to notify the information about the target device being abnormal in response to an operation state of the target device being determined to be abnormal,
wherein the output controller is configured to cause information about a first target device being abnormal set to a first priority to be output using the user interface, and
wherein the output controller is configured to cause information about a second target device being abnormal set to a second priority higher than the first priority to be output using an output unit different from the user interface, in addition to the user interface.

18. A device management system comprising:
a plurality of situation grasping devices provided in a room, each of which is configured to grasp a surrounding situation; and
an image forming apparatus that is provided in the room, is configured to form an image on a recording material, and includes at least one processor configured to execute:
a communication unit configured to communicate with the plurality of situation grasping devices; and
an output controller configured to, in response to the communication unit trying to communicate with one of the plurality of situation grasping devices and the one of the plurality of situation grasping devices being abnormal, output information about the one of the plurality of situation grasping devices being abnormal.

19. A non-transitory computer readable medium storing a program causing a computer provided in an image forming apparatus to execute a process, the process comprising:
communicating with a target device; and
outputting, by controlling at least one processor, in response to trying to communicate with the target device and the target device being abnormal, information about the target device being abnormal.
